(19) United States
(12) Patent Application Publication
(10) Pub. No.: US 2026/0097585 A1
(43) Pub. Date: Apr. 9, 2026

(54) INKJET RECORDING DEVICE AND METHOD FOR CONTROLLING INKJET RECORDING DEVICE

(71) Applicant: Hitachi Industrial Equipment Systems Co., Ltd., Tokyo (JP)

(72) Inventors: Takahiro ARIMA, Tokyo (JP); Kazuhiko TANIGUCHI, Tokyo (JP); An QIU, Tokyo (JP)

(21) Appl. No.: 19/294,463

(22) Filed: Aug. 8, 2025

(30) Foreign Application Priority Data
Oct. 9, 2024 (JP) 2024-177254

(51) Int. Cl. B41J 2/17; B41J 2/045; B41J 2/165; B41J 2/175

(52) U.S. Cl. CPC B41J 2/1707; B41J 2/04508; B41J 2/04571; B41J 2/04581; B41J 2/16552; B41J 2/1721; B41J 2/17563; B41J 2/17596

(57) ABSTRACT

An operation of an inkjet recording device is performed without performing operations, such as interruption of an ink circulation process in an idle state and resetting, in a state in which execution of the ink circulation process is maintained. Ink is supplied to a nozzle to perform printing on a printing target. An idle-mode ink circulation process circulates ink in an idle state, the idle-mode ink circulation process repeating the circulation of the ink in a path, and a standby state at a predetermined time interval. An operation display unit displays a standby screen for the idle-mode ink circulation process and displays information for operating the inkjet recording device on the standby screen in a state in which execution of the idle-mode ink circulation process is maintained. The inkjet recording device receives an operation of the inkjet recording device based on the information displayed on the standby screen.

### CROSS-REFERENCE TO RELATED APPLICATION

The present application claims priority from Japanese application JP2024-177254, filed on October 9, 2024, the content of which is hereby incorporated by reference into this application.

### BACKGROUND OF THE INVENTION

### 1. Field of the Invention

The present invention relates to an inkjet recording device and a method for controlling an inkjet recording device.

### 2. Description of the Related Art

In the related art, there is a technique that automatically circulates ink when an inkjet recording device, such as an inkjet printer, is in an idle state (for example, Japanese Patent Application Publication No. 2024-53031).

In the technique according to the related art, such as the technique disclosed in Japanese Patent Application Publication No. 2024-53031, when ink is circulated in an idle state, various operations (for example, an operation of changing a print font size or a character pattern) on the inkjet recording device need to be performed after the circulation is interrupted. In addition, when the operation is ended, resetting for performing the ink circulation process is required in order to restart the ink circulation process. Therefore, when an operator forgets to perform the resetting after the interruption, there is a possibility that the ink circulation process will not be performed and ink coagulation will occur. Therefore, in order to eliminate this possibility, there is a demand for a technique that receives various operations on the inkjet recording device, without performing operations, such as interruption of the ink circulation process and resetting, even when ink is circulating in the idle state.

### SUMMARY OF THE INVENTION

An object of the present invention to provide a technique that enables an operator to perform an operation on an inkjet recording device, without performing operations, such as interruption of an ink circulation process in an idle state and resetting, in a state in which execution of the ink circulation process is maintained.

According to an aspect of the present invention, there is provided an inkjet recording device ejecting ink supplied from an ink container from a nozzle to perform printing on a printing target. The inkjet recording device includes: a control unit executing an idle-mode ink circulation process of circulating ink in an idle state of the inkjet recording device, the idle-mode ink circulation process repeating the circulation of the ink in a path and a standby state at a predetermined time interval; and an operation display unit displaying a standby screen for the idle-mode ink circulation process. The operation display unit displays information for operating the inkjet recording device on the standby screen in a state in which the control unit maintains the execution of the idle-mode ink circulation process, and the inkjet recording device receives an operation on the inkjet recording device based on the information displayed on the standby screen.

According to the aspect of the present invention, it is possible to perform an operation on the inkjet recording device, without performing operations, such as interruption of the ink circulation process in the idle state and resetting, in a state in which the execution of the ink circulation process is maintained. Issues, configurations, and effects other than those described above will become apparent from the following description of the embodiments.

### BRIEF DESCRIPTION OF THE DRAWINGS

FIG. 1 is a perspective view showing an example of a usage situation of an inkjet recording device;

FIG. 2 is a diagram showing an example of an overall path configuration of the inkjet recording device;

FIG. 3 is a diagram showing an example of a schematic configuration of a control unit and a printing mechanism unit (a main body and a print head) of the inkjet recording device;

FIG. 4 is a diagram showing an example of a fluid path diagram in which a flow of a liquid is represented by thick lines when ink is circulating in the main body;

FIG. 5 is a diagram showing an example of a fluid path diagram in which the flow of the liquid and a flow of gas are represented by thick lines when the ink is circulating in the main body and the print head;

FIG. 6 is a diagram showing an example of a flow of the ink when nozzle cleaning and circulation path cleaning are being performed;

FIG. 7 is a diagram showing an example of an ink circulation function setting screen when ink circulation is stopped in the head mounting unit of the inkjet recording device for a long period of time;

FIG. 8 is a flowchart showing ink circulation when the operation of the inkjet recording device is stopped for a long period of time;

FIG. 9 is a flowchart showing an example of a procedure of a process (operation receiving process) of receiving various operations from an operation display unit 8 when an idle-mode automatic circulation process is being executed;

FIG. 10 is a diagram showing an example of a standby screen in the idle-mode automatic circulation process;

FIG. 11 is a diagram showing an example of a home screen for receiving various operations on the inkjet recording device;

FIG. 12 is a flowchart showing an example of a procedure of a process (cartridge replacement process) for replacing a cartridge when the idle-mode automatic circulation process is being executed;

FIG. 13 is a diagram showing an example of a replacement screen in the idle-mode automatic circulation process;

FIG. 14 is a flowchart showing an example of a procedure of a process (direct operation receiving process) of receiving a direct operation when the idle-mode automatic circulation process is being executed;

FIG. 15 is a diagram showing an example of the standby screen when the print head is removed during the execution of the idle-mode automatic circulation process;

FIG. 16 is a diagram showing an example of the standby screen when the print head is set during the execution of the idle-mode automatic circulation process;

FIG. 17 is a diagram showing an example of the standby screen on which a warning message is displayed;

FIG. 18 is a flowchart showing an example of a procedure of a process of receiving a detection direct operation (detection direct operation receiving process) when the idle-mode automatic circulation process is being executed;

FIG. 19 is a diagram showing an example of the standby screen when the amount of liquid in a collection container is larger than a predetermined amount during the execution of the idle-mode automatic circulation process;

FIG. 20 is a diagram showing an example of the standby screen when the collection container subjected to a waste liquid disposal operation is set during the execution of the idle-mode automatic circulation process; and

FIG. 21 is a diagram showing an example of the standby screen on which a warning message is displayed.

### DETAILED DESCRIPTION OF THE PREFERRED EMBODIMENTS

Hereinafter, embodiments of the present invention will be described with reference to the drawings. The following is an example for describing the present invention, and some omissions and simplifications have been made as appropriate for clarity of explanation. The present invention can be embodied in various other forms. Unless otherwise specified, each component may be singular or plural. The position, size, shape, range, and the like of each component in the drawings may not represent the actual position, size, shape, range, and the like of each component in order to facilitate understanding of the invention. Therefore, the present invention is not necessarily limited to the position, size, shape, range, and the like disclosed in the drawings.

For example, various types of information may be described using expressions such as a "tables, a "list", and a "queue". However, the various types of information may be expressed by data structures other than these. For example, various types of information, such as an "XX table", an "XX list", and an "XX queue", may be referred to as "XX information". When identification information is described, expressions, such as "identification information", an "identifier", a "name", an "ID", and a "number", are used, and these expressions are interchangeable.

When there are a plurality of components having the same or similar function, the plurality of components may be described using the same reference numerals with different subscripts. In addition, when the plurality of components do not need to be distinguished from each other, the subscripts may be omitted in the description.

A process that is performed by executing a program may be described below. Here, a computer executes the program using a processor (for example, a CPU or a GPU) and performs the process defined by the program while using a storage resource (for example, a memory), an interface device (for example, a communication port), and the like. Therefore, the subject of the process performed by executing the program may be the processor. Similarly, the subject of the process performed by executing the program may be a controller, a device, a system, a computer, or a node having the processor. In addition, the subject of the process performed by executing the program may be an arithmetic unit or may include a dedicated circuit for performing a specific process. Here, examples of the dedicated circuit include a field programmable gate array (FPGA), an application specific integrated circuit (ASIC), and a complex programmable logic device (CPLD).

The program may be installed in the computer from a program source. The program source may be, for example, a program distribution server or a computer-readable storage medium. When the program source is the program distribution server, the program distribution server may include a processor and a storage resource for storing the program to be distributed, and the processor of the program distribution server may distribute the program to be distributed to other computers. Further, in the following description, two or more programs may be implemented as one program, and one program may be implemented as two or more programs.

### Usage State

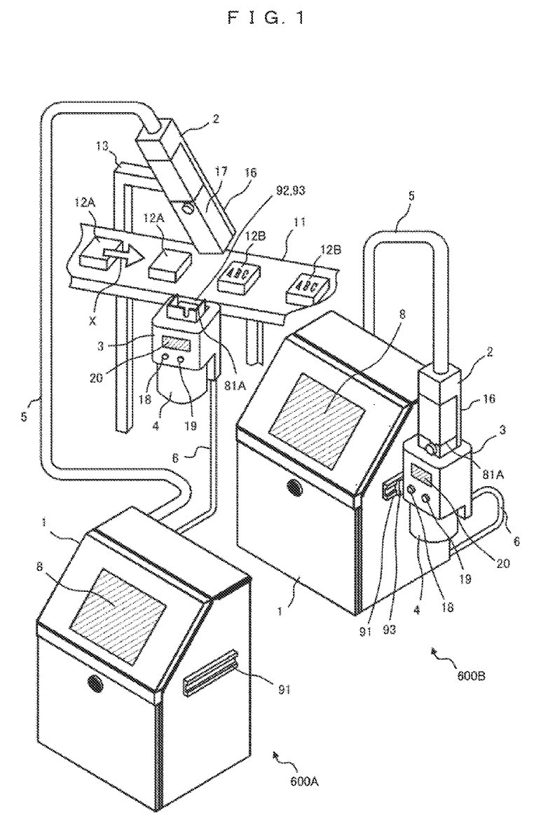

First, a usage state of an inkjet recording device will be described using FIG. 1. FIG. 1 is a perspective view showing the usage state of the inkjet recording device.

In FIG. 1, each of inkjet recording devices 600A and 600B include a main body 1, a print head 2 that is connected to the main body 1 by a cable (for the print head) 5, and a head mounting unit 3 that is connected to the main body 1 by a cable (for the head mounting unit) 6. Here, the head mounting unit 3 basically has a function of accommodating the print head and may also have an additional function of jetting a cleaning liquid to clean the print head. The head mounting unit 3 that will be described below is configurated to have an additional function of cleaning the print head. The inkjet recording device 600A is in a state in which the print head 2 is installed on a production line. In addition, the inkjet recording device 600B is in a state in which the print head 2 is removed from the production line and mounted (set) on the head mounting unit 3. Further, a collection container 4 that is attached to a lower portion of the head mounting unit 3 is provided to contain the liquid (cleaning liquid) remaining after the head mounting unit 3 has cleaned the print head.

The inkjet recording device 600A is installed, for example, on a production line in a factory in which food, beverages, and the like are produced, and the main body 1 is installed in a location where a space required for regular maintenance work and the like can be secured. The print head 2 is fixed to a print head fixing bracket 13 that is installed in the vicinity of a conveyor belt 11 and is installed close to printing targets 12A and 12B that are fed in a direction of an arrow X on the production line, such as the conveyor belt 11, in order to perform printing on the printing targets 12A and 12B. In addition, a protective cover 17 is attached to the print head 2 in order to protect components inside the print head 2. Further, FIG. 1 shows a state in which the printing by the print head 2 is ended and the printing target 12B is transported on the belt conveyor 11.

Furthermore, in FIG. 1, the main body 1 contains (holds) ink for printing and controls driving units (pumps and solenoid valves) inside the main body such that the ink is supplied to the print head 2 via the cable (for the print head) 5. In addition, an internal path configuration of the main body 1 and a control unit will be described in detail below. An operation display unit 8 is provided in an upper surface portion of the main body 1. Here, a touch input display panel is used. An operator can touch the operation display unit 8 to input instructions to start and stop the device to the control unit or to set content to be printed on the printing target 12A. Further, in FIG. 1, reference numeral 16 in the print head 2 denotes a head base, and reference numeral 17 denotes a protective cover.

The head mounting unit 3 is installed around the print head 2. The head mounting unit 3 in the inkjet recording device 600A is fixed by combining a fitting portion 93 provided in the head mounting unit 3 with a fixing jig 92 provided in the belt conveyor 11. In addition, the head mounting unit 3 has a head mounting portion 81A for mounting the print head 2 on the head mounting unit. Further, the head mounting unit 3 has a start button 18 for starting a cleaning process of the print head 2, a stop button 19 for stopping the cleaning process of the print head 2, and a display unit 20 for allowing the operator to recognize alarms such as confirmation messages, warnings, and abnormalities. The display unit 20 may be configured to allow the operator to recognize an operating state and the presence or absence of an abnormality, for example, through the presence or absence of light from a lamp or a difference in color.

In the inkjet recording device 600A, the head mounting unit 3 is fixed in the vicinity of the belt conveyor 11. However, the head mounting unit 3 can be freely moved to a location where it is easy for the user to operate the head mounting unit 3. In addition, it is preferable that the length of the cable (for the head mounting unit) 6 connecting the main body 1 and the head mounting unit 3 is equal to or longer than the length of the cable 5 connecting the main body 1 and the print head 2 of the inkjet recording device 600. This is to ensure flexibility in the disposition of the head mounting unit.

Further, the main body 1 has a fixing portion 91 for fixing the head mounting unit 3, and the head mounting unit 3 can be removed from the fixing jig (for the conveyor) 92 and attached to the fixing portion 91 for use. When the inkjet recording device 600B is in use, the head mounting unit 3 can be fixed to the main body 1 by combining the fitting portion 93 with the fixing portion 91 provided in the main body 1. The head mounting unit 3 of the inkjet recording device 600B is attached to the main body 1. Since the head mounting unit 3 can be fixed to the main body 1, it is possible to install the head mounting unit 3 even when there is no space to attach the head mounting unit 3, for example, in the vicinity of the belt conveyor 11.

Next, a state in which the print head 2 is set in the head mounting unit 3 in the inkjet recording device 600B will be described. The print head 2 is mounted and set in the head mounting portion 81A of the head mounting unit 3 from a leading end of the print head 2. Since the print head 2 is set in the head mounting unit in this manner in the inkjet recording device 600, it is possible to clean the print head 2 with a solvent 69A supplied from the main body 1 via the cable (for the head mounting unit) 6.

### Path Configuration

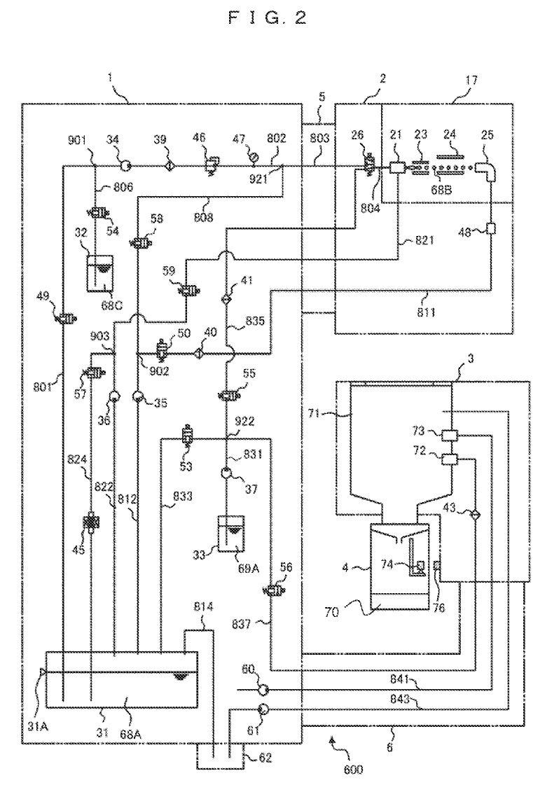

Next, the path configuration of the inkjet recording device 600 will be described with reference to FIG. 2. FIG. 2 is a diagram showing the overall path configuration of the inkjet recording device 600.

First, an ink supply path (paths 801 to 804) of the inkjet recording device 600 will be described. In FIG. 2, the main body 1 includes an ink container 31 that holds ink 68A for printing. The ink container 31 includes a liquid level sensor 31A that detects whether or not a liquid (ink 68A) in the ink container 31 has reached a reference liquid level which is an appropriate amount to be held inside the ink container 31.

A portion of the ink container 31 that is immersed in the ink 68A is connected to the path (for supply) 801, and a solenoid valve (for supply) 49 for opening and closing the path is disposed in the middle of the path 801. In addition, the path 801 is connected to a pump (for supply) 34, which is installed in the path 802 and is used to suck and pressurize the ink 68A, via a junction path 901. Then, the path 801 is connected to a filter (for supply) 39, which removes a foreign matter mixed in the ink 68A, on the output side of the pump (for supply) 34.

The filter (for supply) 39 is connected to a pressure adjusting valve 46 that adjusts the pressure of the ink 68A pressurized from the pump (for supply) 34 to an appropriate pressure for printing, and the pressure adjusting valve 46 is connected to a pressure sensor 47 that measures the pressure of the ink 68A supplied to a nozzle 21. The path 802 in which the pressure sensor 47 is disposed is connected to the path 803, which passes through the cable (for the print head) 5, via a branch path 921, and the path 803 is connected to a switching valve 26 that is provided in the print head 2 and is used to control whether or not to supply the ink 68A to the nozzle 21.

The switching valve 26 is connected to the nozzle 21, which has an ejection port 21A for ejecting the ink 68A, via the path 804. In addition, the switching valve 26 is a three-way solenoid valve, and the path 802 for ink supply and a path 835 for nozzle cleaning are connected to the switching valve 26 such that the supply of the ink 68A and the solvent 69A to the nozzle 21 can be switched. A charging electrode 23 for applying a predetermined amount of charge to ink particles 68B, a deflection electrode 24 for deflecting the ink particles 68B to be used for printing, and a gutter 25 for capturing the ink particles 68B that are not used for printing and fly in a straight line without being charged or deflected are disposed in a straight-line direction of the ejection port 21A of the nozzle 21.

Next, ink collection paths 811 and 812 of the inkjet recording device 600 will be described. In FIG. 2, the gutter 25 is connected to the path 811, and a charge sensor 48 for detecting whether or not the ink particles 68B, to which the charge has been applied by the charging electrode 23, are being collected is disposed in the path 811. In addition, the path 811 passes through the cable (for the print head) 5 and is connected to a filter (for collection) 40 that is disposed in the main body 1 and removes the foreign matter mixed in the ink. The filter (for collection) 40 is connected to a solenoid valve (for collection) 50 that opens and closes the path.

The solenoid valve (for collection) 50 is disposed in the path 812 connected via a junction path 902 and is connected to a pump (for collection) 35 that sucks the ink particles 68B captured by the gutter 25. The pump (for collection) 35 is connected to the ink container 31. When the solenoid valve 50 is opened and the pump 35 is driven, the ink particles 68B captured by the gutter 25 are collected in the ink container 31.

Next, an exhaust path (path 814) of the inkjet recording device 600 will be described. An upper space of the ink container 31 that does not contact the ink 68A is connected to the path 814, and the path 814 is connected to an exhaust duct connection portion 62 that communicates with the outside of the main body 1.

Next, an ink circulation path (paths 821 and 822) of the inkjet recording device 600 will be described. The nozzle 21 provided in the print head 2 is connected to the path 821 that passes through the cable (for the print head) 5, in addition to the path 804 for ink supply. A solenoid valve (for circulation) 59 that is provided in the main body 1 and opens and closes the flow path is disposed in the path 821. The solenoid valve (for circulation) 59 is connected to the path 822 via a junction path 903, and a pump (for circulation) 36 that sucks the ink from the nozzle 21 is disposed in the path 822. In addition, the pump (for circulation) 36 is connected to the ink container 31.

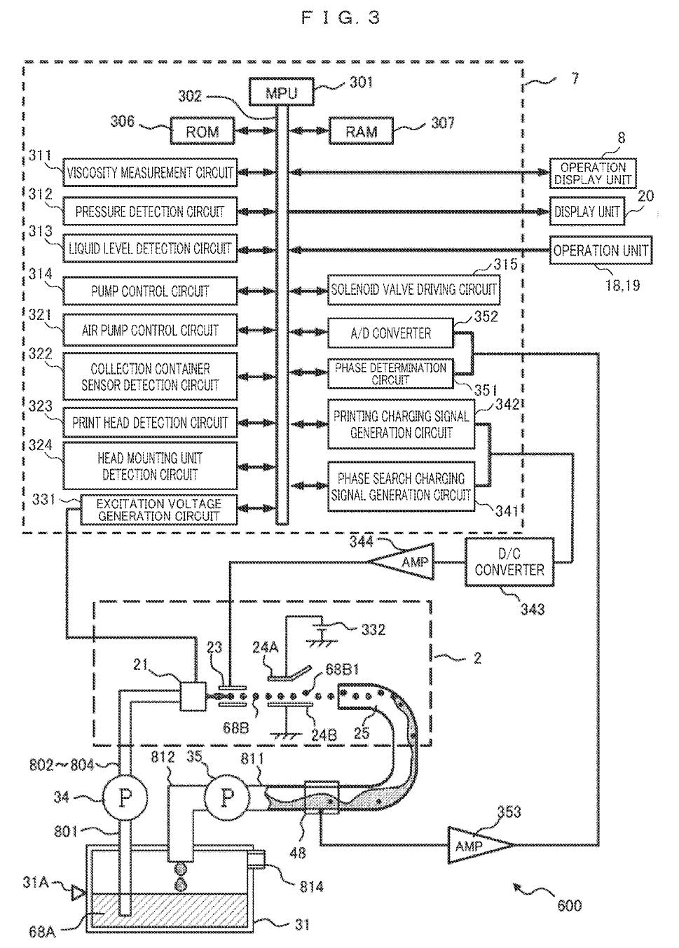

Next, a viscosity measurement path (824 and 822) of the inkjet recording device 600 will be described. In FIG. 2, a portion of the ink container 31 that is immersed in the ink 68A is connected to the path (for viscosity measurement) 824. The path (for viscosity measurement) 824 is connected to a viscosity measurement device 45 in order to know the viscosity of the ink 68A in the ink container 31. The viscosity measurement device 45 is connected to a solenoid valve (for viscosity measurement) 57 that opens and closes the path. The solenoid valve (for viscosity measurement) 57 is connected to the pump (for circulation) 36 disposed in the path 822 via the junction path 903. This makes it possible to circulate the ink 68A in the ink container 31 through the viscosity measurement path and to measure the viscosity of the ink 68A. The viscosity measured in this manner is input to a control unit 7 (not shown in FIG. 2; see FIG. 3) and is used to control the viscosity of the ink 68A in the ink container 31.

Next, a solvent replenishment path (paths 831 and 833) of the inkjet recording device 600 will be described. In FIG. 2, the main body 1 includes a solvent container 33 that holds the solvent 69A to be supplied to the ink container 31 and to be used for nozzle cleaning or head cleaning. A portion of the solvent container 33 that is immersed in the solvent 69A is connected to the path 831, and a pump (for a solvent) 37 used to suck and pressurize the solvent is disposed in the path 831. In addition, the pump (for solvent) 37 is connected to a branch path 922 in order to change a supply destination of the solvent 69A, depending on the purpose. In the solvent replenishment path, the branch path 922 is connected to a solenoid valve (for solvent replenishment) 53 in order to open and close a flow path disposed in the path 833, and the solenoid valve (for solvent replenishment) 53 is connected to the ink container 31. The control unit 7 controls the viscosity of the ink 68A in the ink container 31 using this path.

Next, an ink replenishment path 806 of the inkjet recording device 600 will be described. In FIG. 2, the main body 1 includes an auxiliary ink container 32 that holds a refill ink 68C. A portion of the auxiliary ink container 32 that is immersed in the ink 68C is connected to the path 806. The path 806 is connected to a solenoid valve (for ink replenishment) 54 that opens and closes the path, and the solenoid valve (for ink replenishment) 54 is connected to the pump (for supply) 34, which is installed in the path 801 and is used to suck and pressurize the ink 68C, via the junction path 901. In addition, the ink container 31 is replenished with the ink 68C in the auxiliary ink container 32 via the nozzle 21, the gutter 25, the path 811, the solenoid valve 50, and the pump 35.

Next, a nozzle cleaning path (paths 831 and 835) of the inkjet recording device 600 will be described. In FIG. 2, the pump (for a solvent) 37 disposed in the path 831 is connected to the path 835 via the branch path 922. The path 835 is connected to a solenoid valve (for nozzle cleaning) 55 for opening and closing the flow path. The solenoid valve (for nozzle cleaning) 55 is connected to a filter (for nozzle cleaning) 41 for removing the foreign matter mixed in the solvent 69A. The filter (for nozzle cleaning) 41 is connected to the switching valve 26, which is provided in the print head 2 and is used to control whether or not to send the solvent 69A for cleaning to the nozzle 21, via the path 835 passing through the cable (for print head) 5.

Next, a main body circulation path (paths 808 and 812) of the inkjet recording device 600 will be described. The path 802 is connected to the path 808 via the branch path 921. The path 808 is connected to a solenoid valve (for main body circulation) 58 that opens and closes the path, and the solenoid valve (for main body circulation) 58 is connected to the pump (for circulation) 35 installed in the path 812 via the junction path 902.

Next, a head cleaning path (paths 831 and 837) of the inkjet recording device 600 will be described. In FIG. 2, the pump (for a solvent) 37 is connected to the path 837 via the branch path 922, and a solenoid valve (for head cleaning) 56 for opening and closing the flow path is disposed in the path 837. The solenoid valve (for head cleaning) 56 is connected to a filter (for head cleaning) 43 that removes the foreign matter mixed in the solvent 69A.

A filter (for head cleaning) 42 is connected to the filter (for head cleaning) 43, which is provided in the head mounting unit 3 and is used to remove the foreign matter initially mixed in the path 837, via the path 837 that passes through the cable (for the head mounting unit) 6. In addition, the output side of the filter (for head cleaning) 43 is connected to a cleaning nozzle 72 that is provided in a cleaning tank 71 of the head mounting unit 3. Here, a space inside the cleaning tank 71 is configured to communicate with a collection container 4 that is installed below the cleaning tank 71. The collection container 4 is provided to store the solvent after cleaning with a cleaning liquid (solvent) ejected from a cleaning nozzle 72 that is connected to the inside of the cleaning tank 71. A float 74 is provided in the collection container 4 in order to detect the liquid level of the solvent after cleaning. When the float 74 having a magnet provided therein reaches a predetermined liquid level, a magnetic sensor A 76 detects the liquid level and outputs, to the control unit (not shown in FIG. 2), information indicating that the cleaning liquid in the collection container 4 has reached the predetermined liquid level.

Next, an air supply path (path 841) of the inkjet recording device 600 will be described. In FIG. 2, the main body 1 includes a pump (for drying) 60 that is used to suck and pressurize air, and the pump (for drying) 60 forms an air suction port that communicates with the inside of the main body 1. The pump (for drying) 60 is connected to an air supply nozzle 73, which is provided in the cleaning tank 71 of the head mounting unit 3, via the path 841 passing through the cable (for the head mounting unit) 6.

Next, an air suction path (path 843) of the inkjet recording device 600 will be described. An air pump (for suction) 61 which is provided in the main body 1 and is used to suck and pressurize air is connected to the cleaning tank 71 provided in the head mounting unit 3 via a path 843 that passes through the cable (for the head mounting unit) 6. In addition, the pump (for suction) 61 is connected to the exhaust duct connection portion 62 that communicates with the outside of the main body 1.

### Configuration of Control Unit

Next, a configuration of the control unit 7 of the inkjet recording device 600 will be described. FIG. 3 is a diagram showing a schematic configuration of the control unit 7 and a printing mechanism unit (the main body 1 and the print head 2) of the inkjet recording device 600. In FIG. 3, reference numeral 301 denotes a micro processing unit (hereinafter, referred to as an MPU) which is a control unit controlling the entire inkjet recording device 600. Reference numeral 302 denotes a bus line having a function of transmitting data, control signals, and the like between devices constituting the control unit. For example, the bus line 302 is used to input data, detection signals, and the like required for calculations of the MPU 301 from each device and to transmit data signals, address signals, and control signals to each device. Reference numeral 306 denotes a read only memory (ROM) that stores control programs and data necessary for the operation of the MPU 301. Reference numeral 307 denotes a random access memory (RAM) that temporarily stores data required by the MPU 301 while the MPU 301 is executing a program. Reference numeral 8 denotes an operation display unit for inputting print content, setting values, and the like and for displaying the input data, print content, and the like. Here, a touch input display panel in which transparent touch switches are superimposed on a surface of a liquid crystal display screen is used as the operation display unit 8.

In addition, the head mounting unit 3 can be controlled by the operation display unit of the control unit 7. When the operation of the head mounting unit 3 is performed near the head mounting unit 3, the operation unit (the start button 18 and the stop button 19) is used instead of the operation display unit 8. In addition, when checking the operating state of the head mounted unit 3, abnormality messages, and the like near the head mounting unit 3, the operator uses the display unit 20 instead of the operation display unit 8.

The print head 2 of the inkjet recording device 600 includes the nozzle 21 that disperses the ink 68A pressurized and supplied from the ink container into particles and ejects the ink particles. The nozzle 21 ejects the ink in a columnar shape, and the ink separates at the tip and is ejected as ink droplets 68B. In addition, the print head 2 includes a charging electrode 23 that surrounds the ink droplets 68B and charges the ink droplet 68B according to the print content.

Furthermore, the print head 2 deflects the ink particles 68B, which are charged by the charging electrode 23 and fly, according to the amount of charge to fly toward the printing target (not shown). Then, the flying ink particles land on the printing target. As a result, printing is performed. A deflection electrode 24 of the print head 2 is composed of a ground electrode 24B and a positive electrode 24A. In addition, the print head 2 includes the gutter 25 capturing the ink particles 68B (unused ink) that have not been used for printing and a charge sensor 48 that generates a phase detection signal corresponding to the amount of charge of the ink particles 68B1 that are slightly charged among the ink particles 68B captured by the gutter 25. In addition, the main body 1 includes a pump (for collection) 35 that collects the ink (ink particles) captured by the gutter 25 into the ink container 31 and the ink collection paths 811 and 812 that connect the gutter 25 and the ink container 31.

Further, the control unit 7 has an excitation voltage generation circuit 331 that excites an electrostrictive element 22 (not shown) provided in the nozzle 21, in order to provide regularity to the timing when an ink column ejected from the nozzle 21 separates into the ink droplets 68B.

Furthermore, the control unit 7 has a printing charging signal generation circuit 342, a phase search charging signal generation circuit 341, a D/A converter 343 that converts a digital charging signal output from these circuits into an analog voltage signal, and an amplifier circuit 344 that amplifies the analog voltage signal output from the D/A converter 343 to generate a charging voltage to be applied to the charging electrode 23. In addition, instead of the configuration in which the printing charging signal generation circuit 342 and the phase search charging signal generation circuit 341 are provided, the above may be implemented by the control of the amount of charge by the control unit using only the printing charging signal generation circuit 342. Further, the inkjet recording device 600 includes a deflection voltage generation circuit 332 that generates a deflection voltage to be applied to the deflection electrode 24.

Moreover, the inkjet recording device 600 includes an amplifier circuit 353 that amplifies an analog phase detection signal output from the charge sensor 48, a phase determination circuit 351 that receives the amplified phase detection signal and determines whether charging is good or bad, and an A/D converter 352 that receives the amplified phase detection signal and performs A/D conversion.

Next, in FIG. 3, the MPU 301 of the control unit 7 is connected, via the bus line 302, to a liquid level detection circuit 313 that manages the liquid level of the ink container 31, a pressure detection circuit 312 that detects whether or not the pressure of the ink 68A supplied to the nozzle 21 is an appropriate value, a viscosity measurement circuit 311 that measures whether or not the viscosity of the ink 68A supplied to the nozzle 21 is an appropriate value for printing, using the viscosity measurement device 45, a pump control circuit 314 that controls each of the pumps 34 to 37 which are provided in the main body 1 and suck and pressurize the ink 68A and the solvent 69A, and a solenoid valve driving circuit 315 that controls the opening and closing operation of each of the solenoid valves 49, 50, and 53 to 59 in each path, and controls each component.

In addition, the MPU 301 is connected, via the bus line 302, to an air pump control circuit 321 that controls the pumps 60 and 61, a collection container sensor detection circuit 322 that detects that the collection container 4 is mounted on the head mounting unit 3 and that the amount of liquid 70 in the collection container 4 is not larger than a predetermined amount, using the magnetic sensor A 76 and a magnet A 75, a print head detection circuit 323 that detects that the print head 2 is mounted on the head mounting unit 3, using a magnetic sensor B 84 and a magnet B 86, on the side of the head mounting unit 3, and a head mounting unit detection circuit 324 that detects that the print head 2 is mounted on the head mounting unit 3, using a magnetic sensor C 28 and a magnet C 87, on the side of the print head 2, and controls each component.

A computer can be used as the control unit 7. Specifically, the control unit 7 can be composed of the MPU 301, memories (306 and 307) that store programs for the operation of the MPU 301 and data and information required for the operation, and a driving unit that operates the print head 2, the head mounting unit 3, and the components in the main body 1 in response to instructions from the MPU 301. Here, a detailed description of the control unit 7 will be omitted.

Next, the inkjet recording device 600 will be described. The same configurations as those in FIGS. 1 to 3 are adopted. Therefore, a description of FIGS. 1 to 3 will be omitted.

### Operation and Flow of Liquid

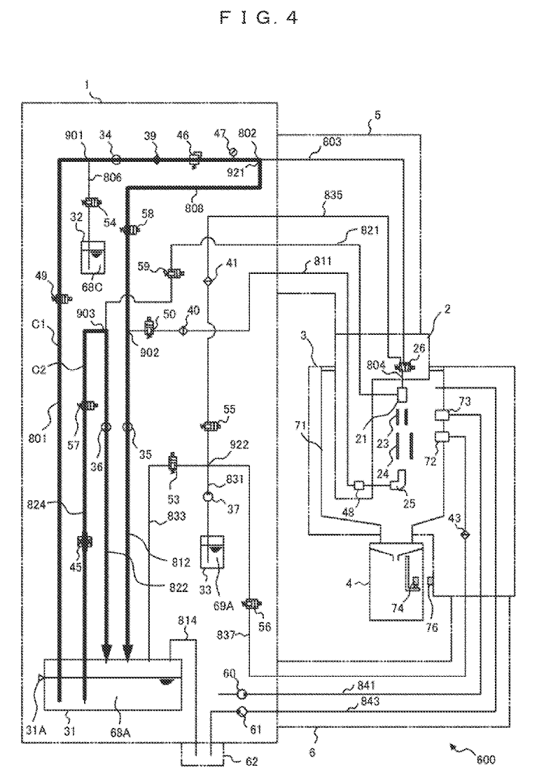

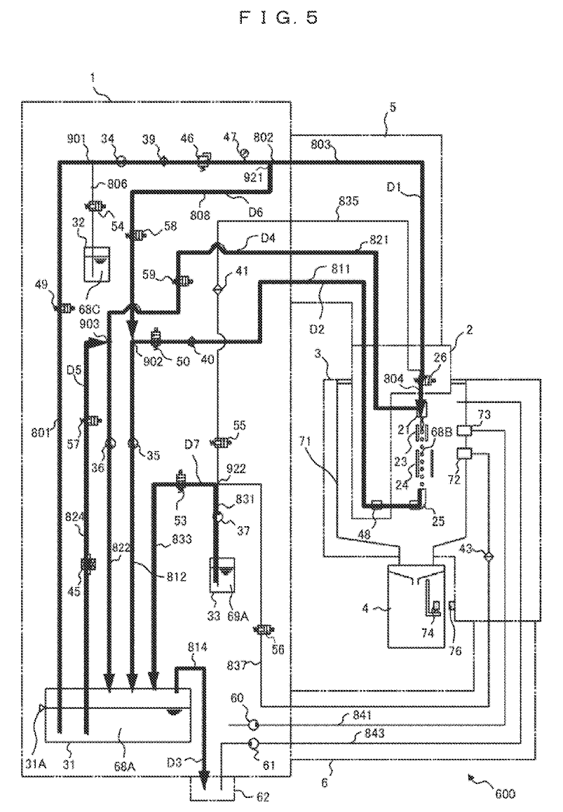

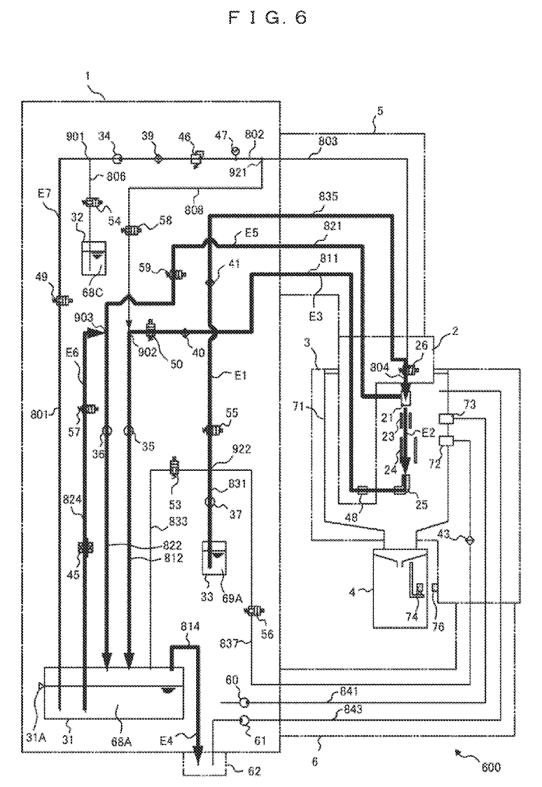

First, an operation when the ink is circulating in the main body 1 and the print head 2 in a state in which the print head 2 is set in the head mounting unit 3 will be described using FIGS. 4 to 6. FIG. 4 is a fluid path diagram in which the flow of liquid when the ink is circulating in the main body is represented by thick lines. FIG. 5 is a fluid path diagram in which the flow of liquid and the flow of gas when the ink is circulating in the main body and the print head are represented by thick lines. FIG. 6 is a diagram showing the flow of the ink when nozzle cleaning and circulation path cleaning are being performed.

FIG. 4 is the fluid path diagram in which the flow of the liquid when the ink is circulating in the main body 1 in a state in which the print head 2 is set in the head mounting unit 3 in the inkjet recording device 600 is represented by thick lines (C1 and C2).

In the main body 1, the solenoid valve (for supply) 49 and the solenoid valve (for main body circulation) 58 are turned on to open the flow path, and the pump (for supply) 34 and the pump (for collection) 35 are operated such that, as represented by the thick line of the arrow C1, the ink 68A contained in the ink container 31 of the main body 1 passes through the solenoid valve (for supply) 49, the pump (for supply) 34, the filter (for supply) 39, the pressure adjusting valve 46, the pressure sensor 47, the solenoid valve (for main body circulation) 58, and the pump (for collection) 35 and returns to the ink container 31. In this way, the ink 68A circulates.

In addition, in the main body 1, the solenoid valve (for viscosity measurement) 57 is turned to open the flow path, and the pump (for circulation) 36 is operated such that, as represented by the thick line of the arrow C2, the ink 68A contained in the ink container 31 of the main body 1 passes through the viscosity measurement device 45, the solenoid valve (for viscosity measurement) 57, and the pump (for circulation) 36 and returns to the ink container 31. In this way, the ink 68A circulates. Further, when the viscosity of the ink 68A is measured using the viscosity measurement device 45 at the timing when the ink circulates in the main body 1, it is easy to understand the state of the ink 68A the next time the device is used.

Next, FIG. 5 is a fluid path diagram in which the flow of the liquid when the ink is circulating in the main body and the print head in a state in which the print head 2 is set in the head mounting unit 3 in the inkjet recording device 600 is represented by thick lines (D1 to D7).

In the ink supply path (paths 801 to 804), the solenoid valve (for supply) 49 is turned on to open the flow path, the switching valve 26 is turned on to connect the ink supply path to the nozzle 21. In this state, the pump (for supply) 34 is operated such that the ink 68A contained in the ink container 31 of the main body 1 is supplied to the nozzle 21 of the print head 2 and ejected as the ink droplets 68B from the nozzle 21, as represented by the thick line of the arrow D1. A voltage is applied to the ink droplet 68B by the charging electrode 23, and the amount of charge is checked by the charge sensor.

In the ink collection paths 811 and 812, the solenoid valve (for collection) 50 is turned on to open the flow path, and the pump (for collection) 35 is operated such that the ink particles 68B and the air around the print head 2 are sucked by the gutter 25 and then sucked and pressurized to the ink container 31 of the main body 1, as represented by the thick line of the arrow D2. In the ink collection paths 811 and 812, the ink 68A and the air flow in a gas-liquid mixture state. Therefore, a solvent component of the ink 68A dissolves in the air, and the air becomes a solvent gas and flows into the ink container 31. The ink that has flowed into the ink container 31 is collected at the bottom, and the air that has become the solvent gas is ejected as the solvent gas to the outside of the main body 1, as represented by the thick line of the arrow D3.

In the inkjet recording device 600, the solvent component in the ink 68A is ejected as the solvent gas to the outside of the device as described above. Therefore, as the operation time increases, the percentage of the solvent component in the ink 68A decreases, and the concentration of the ink 68A increases. Conversely, as the operation time decreases, the concentration of the ink decreases due to the solvent 69A that has flowed into the ink container 31 by the nozzle cleaning process or the like. Therefore, in the paths (for viscosity measurement) 824 and 822, the solenoid valve (for viscosity measurement) 57 is turned on to open the flow path, and the pump (for circulation) 36 is operated such that, as represented by the thick line of the arrow D5, the ink 68A in the ink container 31 is sent to the viscosity measurement device 45 and the viscosity (converted to concentration) of the ink 68A is periodically measured. The detection value of the measured viscosity is input to the control unit 7. As a result, the control unit 7 performs control such that the ink container 31 is replenished with the ink 68C in the auxiliary ink container 32 when the concentration of the ink 68A is low and the ink container 31 is replenished with the solvent 69A in the solvent container 33 when the concentration of the ink 68A is high, as represented by the thick line of the arrow D7. As described above, in the inkjet recording device 600, the viscosity of the ink 68A is controlled to fall within the range of a management value.

In addition, in the ink circulation paths 821 and 822, as represented by the thick line of the arrow D1, in a state in which the ink 68A is supplied from the ink container 31 to the nozzle 21, the solenoid valve (for circulation) 59 is turned on to open the flow path, and the pump (for circulation) 36 is operated such that at least a portion of the ink 68A supplied to the nozzle 21 is sucked into the pump (for circulation) 36, and the ink 68A is circulated so as to return to the ink container 31 in the flow represented by the thick line of the arrow D3. In addition, before the switching valve 26 is turned on, the solenoid valve (for main body circulation) 58 is turned on to open the flow path, and the pump (for circulation) 36 is operated such that the ink 68A can also be circulated through the path (for main body circulation) 808, as represented by the thick line of the arrow D6.

Next, FIG. 6 is a diagram in which the flow of the ink when nozzle cleaning and circulation path cleaning are being performed in a state in which the print head 2 is set in the head mounting unit 3 in the inkjet recording device 600 is represented by thick lines (E1 to E7).

In the nozzle cleaning path (paths 831 and 835), the solenoid valve (for nozzle cleaning) 55 is turned on to open the flow path, and the pump (for solvent) 37 is operated such that the solvent 69A contained in the solvent container 33 of the main body 1 is supplied to the print head 2 and ejected from the nozzle 21, as represented by the thick line of the arrow E1. Then, in the ink collection paths 811 and 812, the solenoid valve (for collection) 50 is turned on to open the flow path, and the pump (for collection) 35 is operated such that the solvent 69A ejected from the nozzle 21 is captured by the gutter 25 and collected in the ink container 31, as represented by the thick line of the arrow E1.

In the ink circulation paths 821 and 822, in a state in which the solvent 69A is supplied from the solvent container 33 to the nozzle 21 as represented by the thick line of the arrow E1, the solenoid valve (for circulation) 59 is turned on to open the flow path, and the pump (for circulation) 36 is operated such that at least a portion of the solvent 69A supplied to the nozzle 21 is sucked into the pump (for circulation) 36 and collected in the ink container 31 in the flow represented by the thick line of the arrow E3. As described above, the inkjet recording device 600 can clean the nozzle 21, the ink paths (for collection) 811 and 812, and the paths (for ink circulation) 821 and 822 using the solvent 69A.

In addition, after the cleaning of the paths (the nozzle 21, the ink collection paths 811 and 812, and the ink circulation paths 821 and 822) is completed, in the main body 1, the solenoid valve (for supply) 49 and the solenoid valve (for main body circulation) 58 are turned on to open the flow path, and the pump (for supply) 34 and pump (for collection) 35 are operated such that the ink 68A contained in the ink container 31 of the main body 1 is circulated as represented by the thick line of the arrow E7.

Furthermore, in the main body 1, the solenoid valve (for viscosity measurement) 57 is turned on to open the flow path, and the pump (for circulation) 36 is operated such that the ink 68A contained in the ink container 31 of the main body 1 is supplied to the viscosity measurement device 45 as represented by the thick line of the arrow E6. At the timing of the ink circulation in the main body 1, the viscosity of the ink 68A is measured using the viscosity measurement device 45, which makes it easy to understand the state of the ink 68A the next time the device is used.

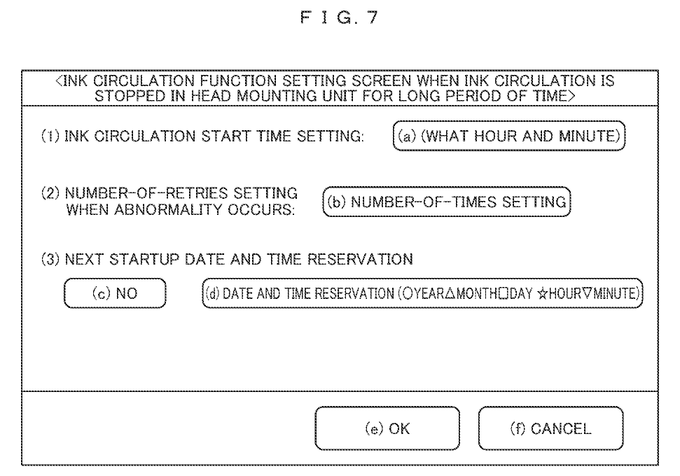

An ink circulation function setting screen when ink circulation is stopped in the head mounting unit of the inkjet recording device 600 for a long period of time will be described using FIG. 7. In addition, the screen shown in FIG. 7 is displayed on the operation display unit 8.

First, "(a) What hour and minute" is input to "(1) Ink circulation start time setting field" on the ink circulation function setting screen when ink circulation is stopped in the head mounting unit for a long period of time. In FIG. 7, as an example, the ink circulation start time "(a) What time and minute" is designated. However, for example, the period from the previous ink circulation start time or the previous ink circulation stop time (for example, the time after 100 hours have passed or the date after 7 days have passed) may be designated, and it may be checked that the designated period has elapsed and ink circulation has started.

Next, "(b) Number-of-times setting" can be set in the range of 0 to 5 in "(2) Number-of-retries setting field when an abnormality occurs" on the ink circulation function setting screen when ink circulation is stopped in the head mounting unit for a long period of time.

Next, either "(c) No or (d) Date and time reservation" is selected in "(3) Next startup date and time reservation field" on the ink circulation function setting screen when ink circulation is stopped in the head mounting unit for a long period of time. When "(c) No" is selected, the ink circulation function when ink circulation is stopped in the head mounting unit for a long period of time is executed, but a startup (ink ejection start) process is not executed at the designated time. When selecting "(d) Date and time reservation", the operator can set the "year, month, day, hour, and minute" at which the operator wants to start ejecting ink in the head mounting unit.

Then, after the settings (1) to (3) are completed on the ink circulation function setting screen when ink circulation is stopped in the head mounting unit for a long period of time, the operator presses either the "(e) OK or (f) Cancel" button. When the "(e) OK" button is pressed, the displayed settings (1) to (3) are overwritten in the control unit 7, and the ink circulation function when ink circulation is stopped in the head mounting unit for a long period of time is started. Further, when the "(f) Cancel" button is pressed, the displayed settings (1) to (3) are not overwritten in the control unit 7, and the ink circulation function when ink circulation is stopped in the head mounting unit for a long period of time is not started.

### Description of Ink Circulation Start Flow When Operation Is Stopped for a Long Period of Time

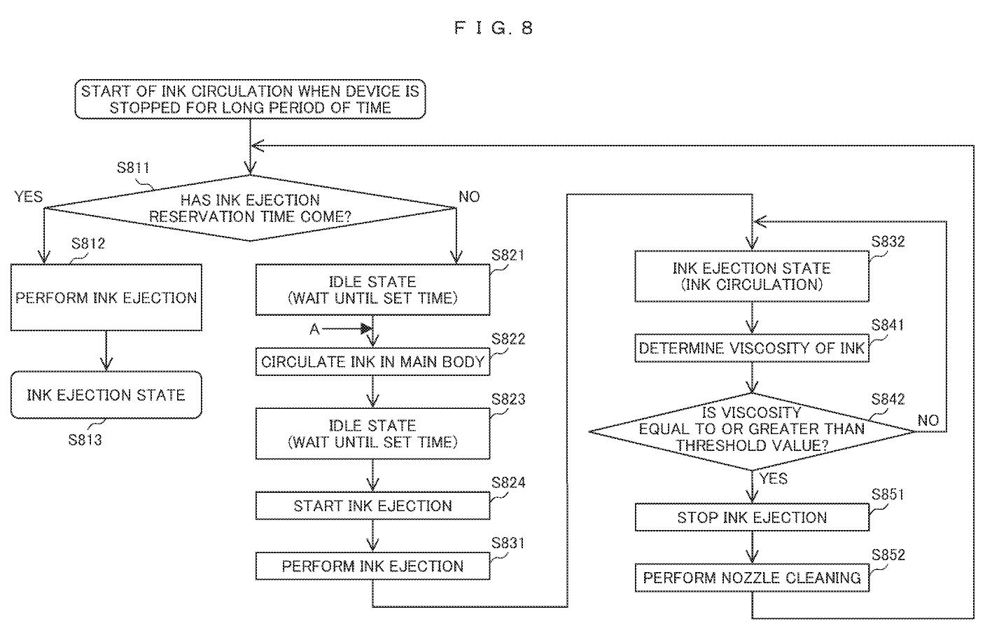

Next, an operation flow of an ink circulation start process when the operation of the inkjet recording device 600 is stopped for a long period of time will be described using FIG. 8. FIG. 8 is a flowchart showing ink circulation when the operation is stopped for a long period of time. In FIG. 8, in the ink circulation start flow when the operation is stopped for a long period of time, it is assumed that, after the start button for performing the ink circulation start process when the operation is stopped for a long period of time, which is displayed on the operation display unit 8, is pressed, the collection container 4 is set (mounted) in the head mounting unit 3, and the print head 2 is set (mounted) in the head mounting unit 3. Hereinafter, the process performed in this state is referred to as an "idle-mode automatic circulation process". As shown in FIG. 8, in the idle-mode automatic circulation process, ink circulation in the path and a standby state are repeated at preset time intervals. In addition, the start button for performing the ink circulation start process when the operation is stopped for a long period of time is effective under the following conditions: the inkjet recording device 600 is in a state in which the ejection of the ink from the nozzle 21 of the print head 2 is stopped and ink circulation system components, such as the pump (for supply) 34 and the solenoid valve (for supply) 49, are not supplied with power and are not operating.

In Step S811, it is confirmed that the content of "(d) Date and time reservation" is set in "(3) Next startup date and time reservation field" on the ink circulation function setting screen when ink circulation is stopped in the head mounting unit for a long period of time which is shown in FIG. 7. Then, when the set reservation time comes, the determination result is "YES", and the process proceeds to Step S812. When the set reservation time does not come, the determination result is "NO", and the process proceeds to Step S821. In addition, when the content set in "(3) Next startup date and time reservation field" shown in FIG. 7 is "(c) No", the determination result is "NO", and the process proceeds to Step S821.

In Step S821, it is confirmed that the content of the setting of "(a) What time and minute" in "(1) Ink circulation start time setting field" on the ink circulation function setting screen when ink circulation is stopped in the head mounting unit for a long period of time which is shown in FIG. 7. The confirmation of the content of the setting here may be confirming that not the ink circulation start time "(a) What time and minute" but, for example, the period from the previous ink circulation start time or the previous ink circulation stop time (for example, the time after 100 hours have passed, the date after 7 days have passed, or the like) has been designated and the ink circulation has started after the designated period has elapsed. The inkjet recording device 600 waits in a standby state (in a state in which the ejection of the ink from the nozzle 21 of the print head 2 is stopped, and the ink circulation system components, such as the pump (for supply) 34 and the solenoid valve (for supply) 49, are not supplied with power and are not operating) until the set time.

In Step S822, the ink circulation in the main body 1 described with reference to FIG. 4 is performed.

In Step S823, the same process as that in Step S821 is executed.

In Step S824, the ink ejection process is started because the time confirmed in Step S821 comes.

In Step S831, the ink ejection process started in Step S824 is performed.

In Step S832, the ink circulation in the main body 1 and the print head 2 described with reference to FIG. 5 is performed.

In Step S841, the viscosity of the ink 68A is measured using the viscosity measurement device 45. Ink concentration is calculated based on the relationship between temperature and viscosity for each type of ink recorded in the control unit 7.

In Step S842, it is determined whether or not the ink concentration calculated in Step S561 is higher than a predetermined threshold value. When the ink concentration is higher than the threshold value, the determination result is "YES", and the process proceeds to Step S851. When the ink concentration is lower than the threshold value, the determination result is "NO", and Step S832 is executed again. In the inkjet recording device 600, the ink concentration of the ink 68A can be increased by performing the ink circulation described with reference to FIG. 5.

In Step S851, the switching valve 26 is turned off to stop the ejection of the ink from the nozzle 21.

The nozzle cleaning and the circulation path cleaning described with reference to FIG. 6 are performed in Step S852, and Step S811 is executed again. In the process from Step S811 to Step S852, the state in which the inkjet recording device 600 waits until the set time in Steps S821 and S823 after the cleaning in Step S852 is performed is called a standby state. The standby state is a state in which the physical mechanisms, such as the print head 2 and the collection container 4, in the inkjet recording device 600 are not used to circulate the ink.

In Step S812, the same ink ejection process as the ink ejection process performed in Step S831 is performed.

Step S813 indicates that the ink is ejected from the nozzle 21 of the print head 2, the ink particles 68B are captured by the gutter 25, a normal charging phase search is performed, and the operation start (ink ejection start) process is completed.

As described above, according to the process shown in FIG. 8, it is possible to provide the inkjet recording device 600 that automatically performs the ink circulation in the main body 1 and the print head 2 after a predetermined period of time has elapsed in order to prevent the ink circulation system components from sticking when the inkjet recording device 600 is not used for a long period of time in a state in which the print head 2 is set (mounted) in the head mounting unit 3 and that can automatically repair itself when a problem, such as beam misalignment, occurs and resume the circulation of the ink to the main body 1 and the print head 2 after a predetermined period of time has elapsed.

Further, according to the process shown in FIG. 8, it is possible to provide the inkjet recording device 600 that can automatically circulate the ink in the main body 1 and the print head 2 after a predetermined period of time has elapsed until the scheduled operation start (ink ejection start) date and time, thereby reducing malfunctions when the operation is started.

### Embodiment 1

In the inkjet recording device according to the related art, when ink is circulated in the standby state, various operations on the inkjet recording device (for example, an operation of changing a print font size or a character pattern) need to be performed after the ink circulation is stopped. In addition, when the operation is ended, in order to restart the circulation, it is necessary to reset the settings for the circulation. Therefore, when the operator forgets to perform the resetting after the ink circulation is stopped, there is a possibility that the ink will not circulate and ink coagulation will occur. In order to eliminate this possibility, a process will be described below that receives various operations on the inkjet recording device while maintaining the execution of the ink circulation process, without performing operations, such as interruption of the ink circulation process and resetting, even when ink is circulating in the idle state.

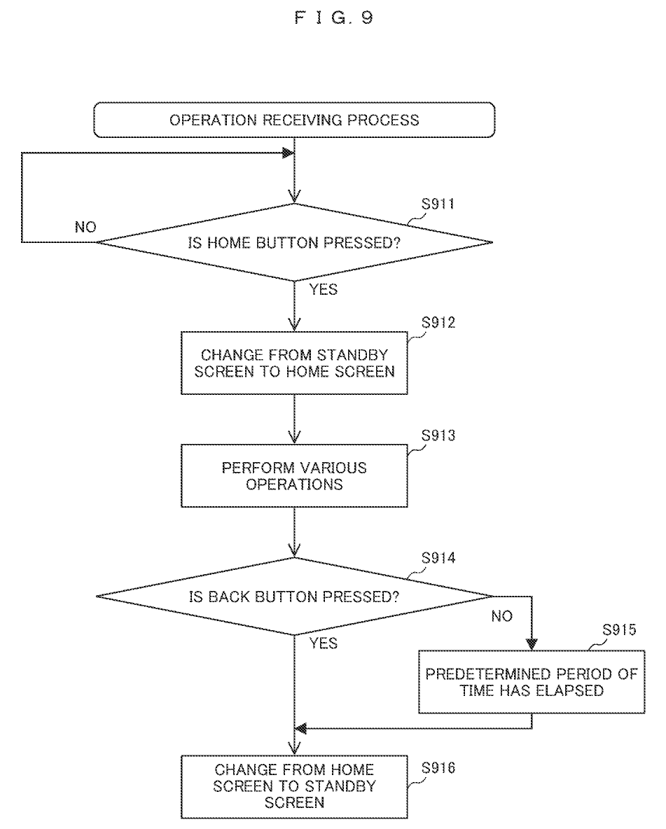

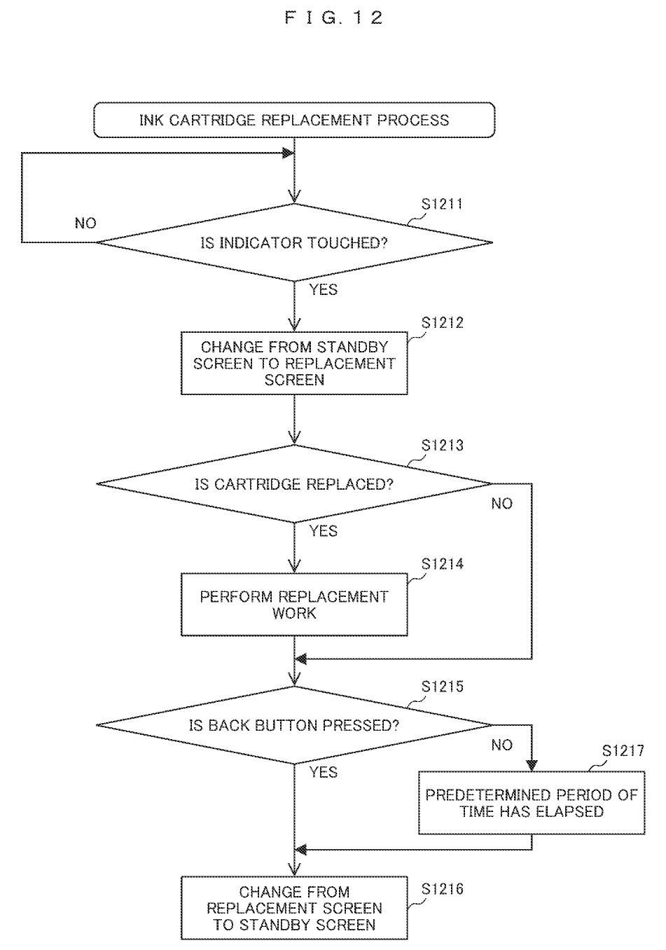

When performing, for example, the idle-mode automatic circulation process, the inkjet recording device 600 receives various operations on the inkjet recording device 600 at any time when physical mechanisms, such as the print head 2 and the collection container 4, in the inkjet recording device 600, are not used to circulate the ink. FIG. 9 is a flowchart showing an example of a procedure of a process (operation receiving process) of receiving various operations from the operation display unit 8 when the idle-mode automatic circulation process is being executed. A case will be described below where various operations are received at a timing A after the process in Step S821 is performed among the processes in Steps S821 to S852 as an example of timing in the idle-mode automatic circulation process. The various operations include, for example, operations controlled by software, such as operations related to printing including an operation of changing a print font size and a character pattern and operations related to the operating environment of the inkjet recording device 600 including an operation of changing the operating time and the language displayed on the operation display unit 8. Meanwhile, even in the idle mode, the ink circulation is performed automatically in a state other than the standby state. Therefore, operations on the physical mechanisms used to circulate the ink, which include the cleaning of the head and the nozzle, are not included in the various operations, which will be described below. The operations on the physical mechanisms will be described below with reference to FIG. 12 and the subsequent figures.

In the operation receiving process shown in FIG. 9, first, when a HOME button displayed on a standby screen in the idle-mode automatic circulation process is pressed (S911; YES), the standby screen is changed to a home screen, and the operation display unit 8 displays the home screen (S912).

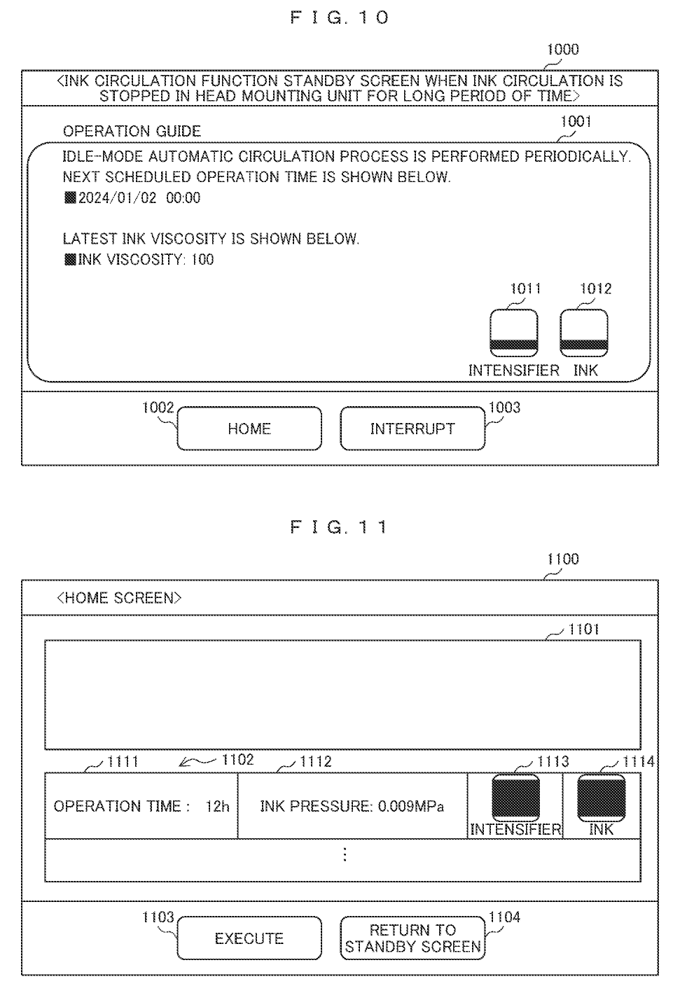

FIG. 10 shows an example of the standby screen in the idle-mode automatic circulation process. The standby screen is displayed when an "(e) OK" button is pressed on the ink circulation function setting screen when ink circulation is stopped in the head mounting unit for a long period of time which is shown in FIG. 7. The standby screen is a screen for putting processes other than the idle-mode automatic circulation process on hold until the idle-mode automatic circulation process is ended.

As shown in FIG. 10, a standby screen 1000 includes an operation guide area 1001 for displaying the state of the inkjet recording device 600 displaying the standby screen, a HOME button 1002 for changing to the home screen for receiving various operations on the inkjet recording device 600, and an interrupt button 1003 for interrupting the idle-mode automatic circulation process. In addition, an indicator 1011 that indicates the state of the remaining amount of intensifier and an indicator 1012 that indicates the remaining amount of ink are displayed in the operation guide area 1001. These indicators are information for the operator to operate the physical mechanisms, such as the print head 2 and the collection container 4, in the inkjet recording device 600 in the standby state of the inkjet recording device 600.

The HOME button 1002 and the interrupt button 1003 are displayed on the standby screen 1000. These buttons are displayed as objects on the screen. Hereinafter, when a button is mentioned, it is assumed that the button is displayed as an object on the screen. In addition, the HOME button 1002 may be provided on the ink circulation function setting screen, and the ink circulation function setting screen may be directly changed to the home screen without being changed to the standby screen. The HOME button 1002 is a button for switching the standby screen 1000 to the home screen on which various other operations are possible.

The next scheduled operation time in the idle-mode automatic circulation process and ink viscosity are displayed in the operation guide area 1001. The next scheduled operation time is the time set on the ink circulation function setting screen shown in FIG. 7. The ink viscosity is the viscosity of the ink measured by the viscosity measurement device 45. In addition, the indicators 1011 and 1012 are displayed based on the detection states of various sensors such as the liquid level sensor 31A, the magnetic sensor A 76, and the magnet A 75.

FIG. 11 is a diagram showing an example of the home screen for receiving various operations on the inkjet recording device 600. The home screen is different from the standby screen and is a screen for receiving operations from the operator when the inkjet recording device 600 is running. The operations include various operations on the inkjet recording device 600 which include operations controlled by software.

As shown in FIG. 11, a process execution state display area 1101 for displaying an execution state of the process of the inkjet recording device 600, an operation area 1102 for receiving various operations, an execution button 1103 for executing various operations, and a back button 1104 for returning the home screen 1100 to the standby screen 1000 after various operations are performed are displayed on the home screen 1100. In addition, the operation area 1102 is provided with an operation display area for receiving various operations or for displaying the current operating state of the inkjet recording device 600.

In FIG. 11, an operation time 1111 of the inkjet recording device 600, an ink pressure 1112, an indicator 1113 indicating the state of the remaining amount of intensifier, and an indicator 1114 indicating the state of the remaining amount of ink are displayed as an example of the operation display areas provided in the operation area 1102. In this example, the operation time of the inkjet recording device 600 is "12 h" and the ink pressure is "0.009 MPa". In addition, the intensifier and the ink are held such that the remaining amounts of intensifier and ink are larger than predetermined amounts. For example, information indicating a processing state, such as the current number of printing operations, is displayed in the process execution state display area 1101. The above-described indicator is the same as the indicator shown in FIG. 10. However, in this example, the indicator indicates a state in which the intensifier and the ink have been replenished by the operation of the operator on the inkjet recording device 600 in this example.

Returning to FIG. 9, when the home screen is displayed in Step S912, the operator performs the above-described various operations (S913). For example, the operator changes the setting value of the ink pressure displayed on the home screen 1100 from "0.009 MPa" to "0.01 MPa".

When the operation display unit 8 receives the pressing of the back button 1104 for returning to the standby screen from the operator after the above-described various operations are ended (S914; YES), the process proceeds to Step S916, and the screen returns to the standby screen 1000 shown in FIG. 10.

On the other hand, when the operation display unit 8 does not receive the pressing of the back button 1104 by the operator (S914; NO), the process proceeds to Step S916 after a predetermined period of time has elapsed (for example, after (3 to 10 minutes) have elapsed) (S915), the process proceeds to S916, and the screen is changed to the standby screen 1000. Then, the process is ended.

As described above, the screen can be switched to receive various operations while the circulation in the idle mode is maintained. Therefore, even when the ink is circulating in the idle state, it is possible to receive various operations controlled by software as various operations on the inkjet recording device, without performing operations such as interruption of the ink circulation process and resetting, which eliminates the need for troublesome operations such as interruption and resetting.

In FIG. 11, it is possible to receive the operations controlled by software as the operations on the inkjet recording device 600 while executing the idle-mode automatic circulation process. However, in some cases, it is necessary to operate the physical mechanisms which are portions that do not affect the ink circulation path, depending on the operating state of the inkjet recording device 600. For example, when the font is blurred due to a lack of the intensifier, it is necessary to immediately replenish the intensifier. Therefore, a case will be described below where, in addition to the operations controlled by software, operations on the physical mechanisms that are not used to circulate the ink are performed. Here, a case where an intensifier cartridge is replaced will be described as an example.

FIG. 12 is a flowchart showing an example of a procedure of a process (cartridge replacement process) of replacing a cartridge when the idle-mode automatic circulation process is being executed.

In the cartridge replacement process shown in FIG. 12, first, when the indicator 1011 indicating the state of the remaining amount of intensifier displayed on the standby screen in the idle-mode automatic circulation process is touched (S1211; YES), the standby screen is changed to a replacement screen, and the operation display unit 8 displays the replacement screen (S1212).

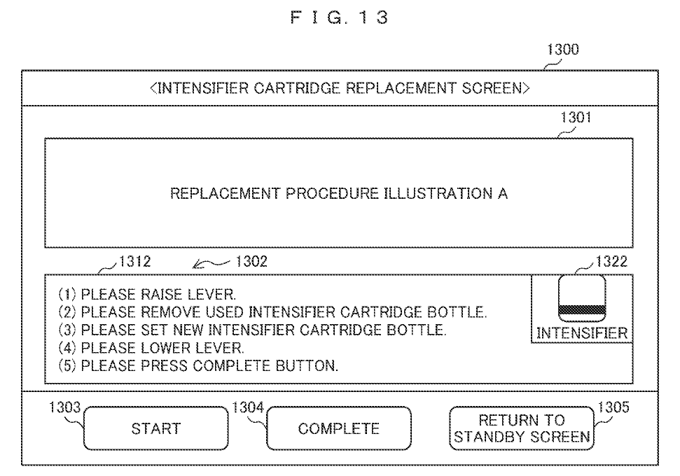

FIG. 13 shows an example of the replacement screen in the idle-mode automatic circulation process. As shown in FIG. 13, a replacement screen 1300 includes a replacement procedure illustration area 1301 for showing the replacement procedure of the intensifier cartridge, a replacement procedure explanation area 1302 for explaining the replacement procedure of the intensifier cartridge, a start button 1303 that is pressed when the replacement of the cartridge is started, a completion button 1304 that is pressed when the replacement of the cartridge has been completed, and a back button 1305 for returning the replacement screen 1300 to the standby screen 1000 when the replacement of the cartridge has been completed. In this example, a replacement procedure illustration A is displayed in the replacement procedure illustration area 1301. In addition, an intensifier cartridge replacement procedure 1322 is displayed in the replacement procedure explanation area 1302 together with an indicator 1322 indicating the state of the remaining amount of intensifier.

When pressing the start button 1303 on the replacement screen 1300 (S1213; YES), the operator performs replacement work according to the replacement procedure (S1214), and the process proceeds to Step S1215.

After the replacement work is completed, the completion button 1304 is pressed. When the cartridge replacement work is completed, the operation display unit 8 further receives the pressing of the back button 1305 on the replacement screen. When the back button 1305 is pressed (S1215; YES), the replacement screen returns to the standby screen 1000 shown in FIG. 10.

On the other hand, when the operation display unit 8 does not receive the pressing of the back button 1305 by the operator (S1215; NO), the process proceeds to S1216 after a predetermined period of time has elapsed (for example, after (3 to 10 minutes) have elapsed) (S1217), and the replacement screen is changed to the standby screen 1000. Then, the process is ended.

As described above, the screen can be switched to receive various operations while the circulation in the idle mode is maintained. Therefore, even when the ink is circulating in the idle state, it is possible to receive various operations on the physical mechanisms, which do not affect the circulation of the ink, as the various operations on the inkjet recording device, without performing operations, such as the interruption of the ink circulation process and resetting, which eliminates the need for troublesome operations such as interruption and resetting.

### Embodiment 2

In Embodiment 1, when the idle-mode automatic circulation process is being performed, the screen is changed from the standby screen 1000 to the home screen 1100 or the replacement screen 1300 such that the operation controlled by software and the operation on the physical mechanisms that are not used to circulate the ink can be performed. Therefore, it is possible to receive various operations, without performing operations such as interruption of the idle-mode automatic circulation process and resetting, while maintaining the ink circulation.

However, the need to receive various operations while maintaining the circulation is not limited to the case where the reception of the operations is performed via a change destination screen such as the home screen 1100 or the exchange screen 1300. That is, in some cases, it is desirable that various operations can be directly executed through the standby screen in a state in which the standby screen is displayed. For example, even during the execution of the idle-mode automatic circulation process, when it is determined that the font is blurred in the printing process of the inkjet recording device 600, it is desirable to immediately perform an operation for checking the contamination of the print head, without interrupting the idle-mode automatic circulation process, from the viewpoint of the load of the printing process performed by the inkjet recording device 600 and the work efficiency of the operator.

Therefore, a case will be described below where, when the standby screen is displayed, the standby screen is not switched and various operations can be received while maintaining the idle-mode automatic circulation process. The various operations in this case include, for example, operations of detaching and attaching the print head from and to the head mounting unit and operations on the physical mechanisms that are not used to circulate the ink, such as operations of detaching and attaching the cleaning liquid collection container from and to the head mounting unit. Since these operations are performed in a state in which the standby screen is displayed without switching the screen, hereinafter, the operations performed on the inkjet recording device 600 are referred to as direct operations. Hereinafter, the same components as those in Embodiment 1 are denoted by the same reference numerals, and a description thereof will be omitted. Configurations different from those in Embodiment 1 will be mainly described.

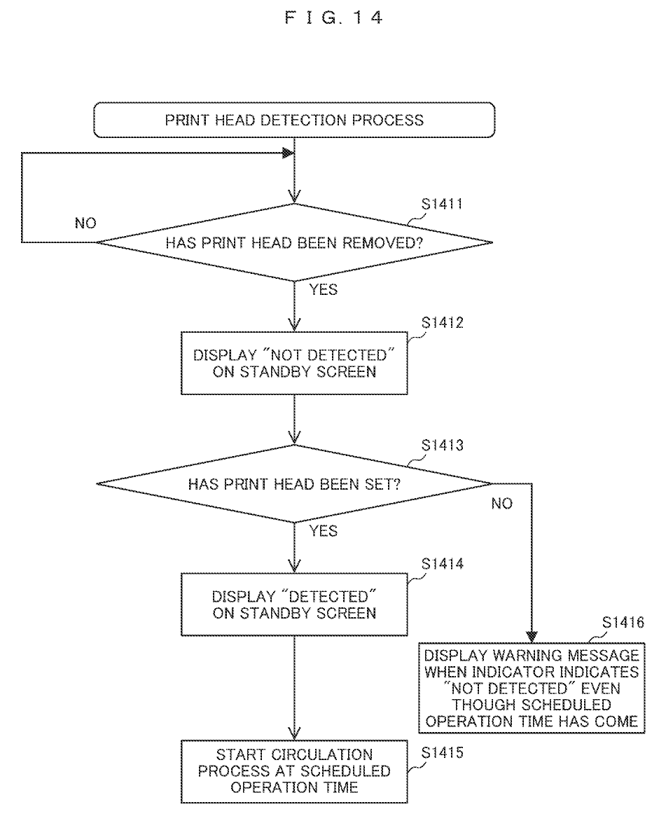

FIG. 14 is a flowchart showing an example of a procedure of a process (direct operation receiving process) of directly receiving operations when the idle-mode automatic circulation process is being performed.

In the direct operation receiving process shown in FIG. 14, first, when the print head 2 is removed in a state in which the standby screen in the idle-mode automatic circulation process is displayed (S1411; YES), the operation display unit 8 changes the display of an indicator indicating the attachment state of the print head on the standby screen from "Detected" to "Not detected" (S1412).

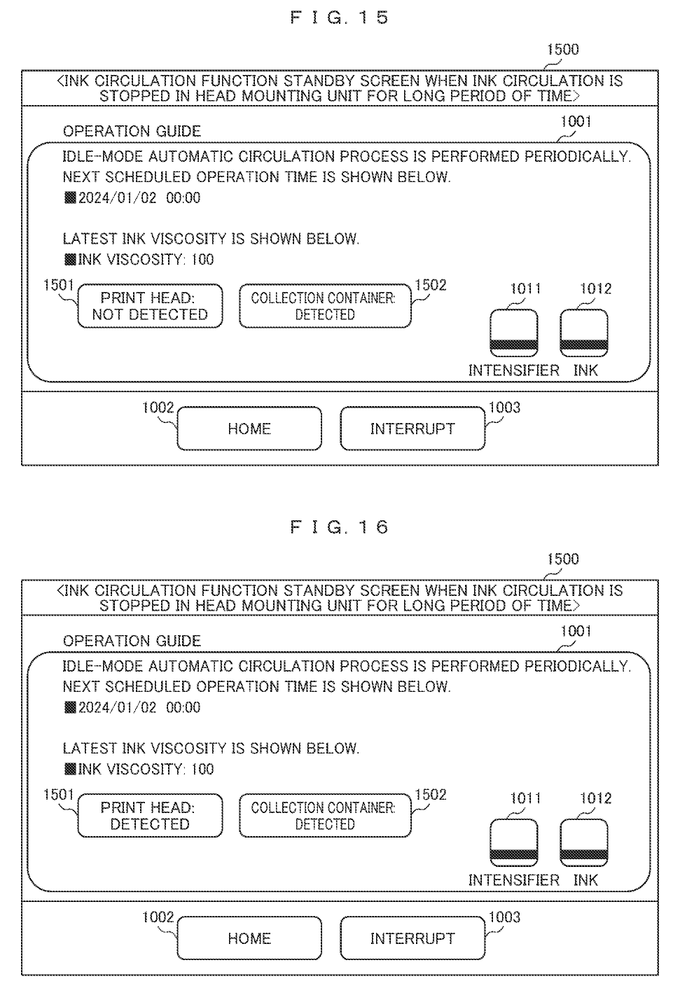

FIG. 15 shows an example of the standby screen when the print head 2 is removed during the execution of the idle-mode automatic circulation process. On a standby screen 1500, a print head indicator 1501, which is an indicator indicating the attachment state of the print head on the standby screen, and a collection container indicator 1502 indicating the attachment state of the collection container on the standby screen, are further displayed in the operation guide area 1001 of the standby screen 1000 in Embodiment 1 shown in FIG. 9. In FIG. 15, since the print head 2 has been removed, the print head indicator 1501 is displayed as "Not detected".

Returning to FIG. 14, when the print head 2 is set (S1413; YES), the operation display unit 8 changes the display of the print head indicator 1501 from "Not detected" to "Detected" (S1414). When the next scheduled operation time comes, the inkjet recording device 600 starts the idle-mode automatic circulation process (S1415).

FIG. 16 is a diagram showing an example of the standby screen when the print head 2 is set during the execution of the idle-mode automatic circulation process. As can be seen from FIG. 16, the print head indicator 1501 on the standby screen shown in FIG. 15 has been changed from "Not detected" to "Detected."

On the other hand, when the print head 2 has not been set (S1413; NO) and the display of the print head indicator 1501 is "Not detected" even after the next scheduled operation time has come, the operation display unit 8 displays a warning message (S1416).

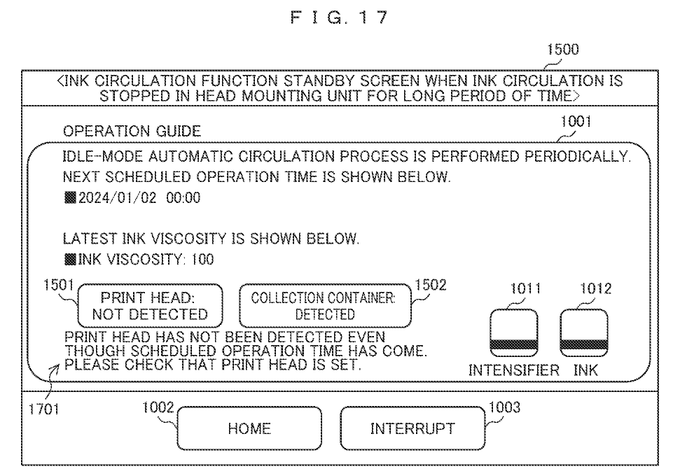

FIG. 17 is a diagram showing an example of the standby screen on which the warning message is displayed. As can be seen from FIG. 17, since the print head 2 has not been set even though the next scheduled operation time has come, a warning message 1701 that indicates the fact and prompts the operator to set the print head 2 is displayed.

As described above, even when the ink is circulating in the idle state, it is possible to receive the operations on the physical mechanisms that are not used to circulate the ink, based on the operator's determination, while displaying the standby screen. Therefore, the operator is freed from troublesome operations such as interrupting, resetting, and screen switching. For example, even when the operator determines that the font is blurred in the printing process, it is possible to check the contamination of the print head, without stopping the idle-mode automatic circulation process, while displaying the standby screen.

In FIGS. 14 to 17, the direct operation on the print head has been described as an example. The same can apply to the collection container. In this case, in the description of FIGS. 14 to 17, the "print head 2" may be read as the "collection container 4". When this embodiment is applied to the cleaning liquid collection container, it is possible to obtain the same effects as those in the case of the print head. For example, even when the operator has not performed a waste liquid disposal operation for a predetermined period of time in the printing process and wants to determine whether or not it is necessary to perform the waste liquid disposal operation immediately, it is possible to check the state of the amount of liquid in the collection container, without stopping the idle-mode automatic circulation process, while displaying the standby screen.

Further, in FIGS. 14 to 17, the case where the direct operation is performed based on the operator's determination during the execution of the idle-mode automatic circulation process has been described. However, the direct operation can be expanded to include not only the case where the direct operation is based on the operator's determination, but also a case where the direct operation is performed based on the detection results of the sensors provided in the inkjet recording device 600, regardless of the operator's determination. For example, when the magnetic sensor A 76 and the magnet A 75 of the inkjet recording device 600 detect that the amount of liquid 70 in the collection container 4 is larger than a predetermined amount, the direct operation receiving process shown in FIG. 14 may be performed. Hereinafter, this direct operation is referred to as a detection direct operation since the direct operation is an operation on the physical mechanism which is an operation target whose state can be detected by the sensors.

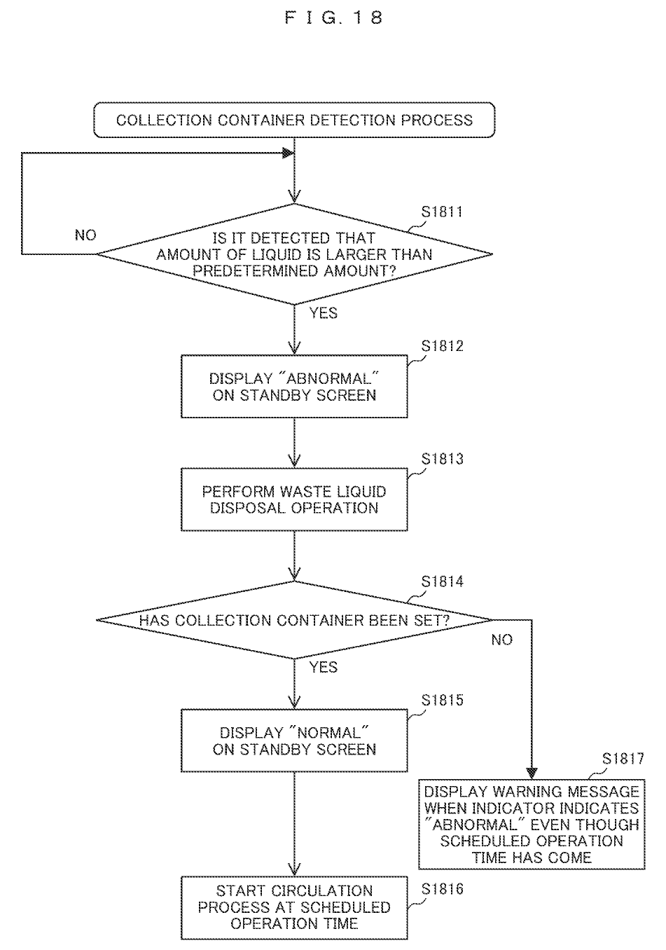

FIG. 18 is a flowchart showing an example of a procedure of a process (detection direct operation receiving process) of receiving the detection direct operation when the idle-mode automatic circulation process is being executed.

In the detection direct operation receiving process shown in FIG. 18, first, when it is detected that the amount of liquid 70 in the collection container 4 is larger than a predetermined amount in a state in which the standby screen in the idle-mode automatic circulation process is displayed (S1811; YES), the operation display unit 8 changes the display of the indicator indicating the attachment state of the collection container on the standby screen from "Normal" to "Abnormal" (S1812).

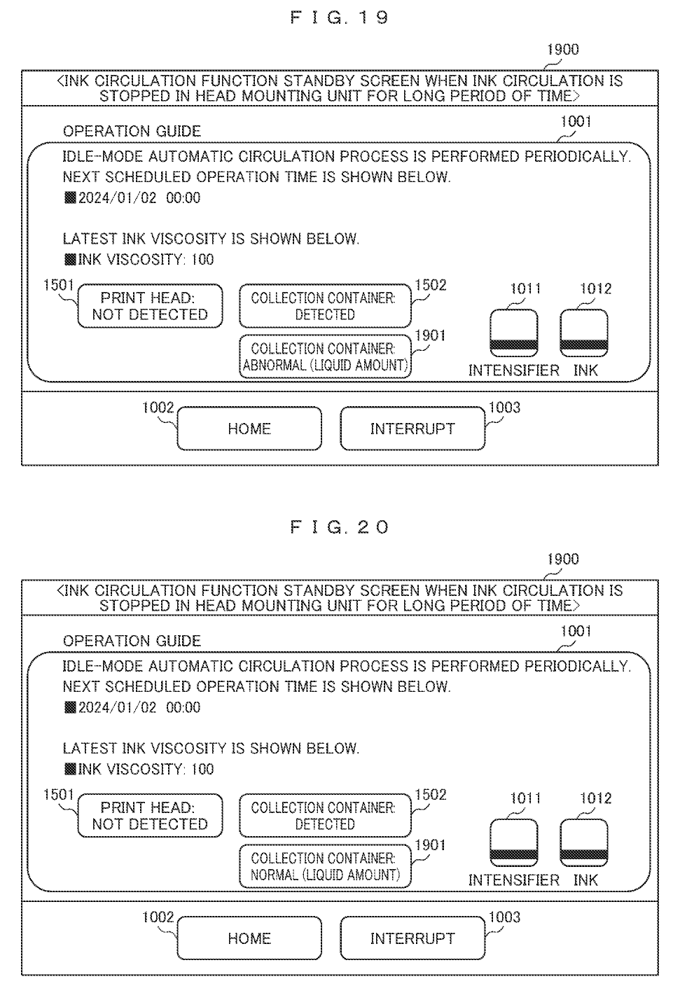

FIG. 19 is a diagram showing an example of the standby screen when the amount of liquid 70 in the collection container 4 is larger than the predetermined amount during the execution of the idle-mode automatic circulation process. On a standby screen 1900, a collection container liquid amount indicator 1901, which is an indicator indicating the state of the amount of liquid 70 in the collection container 4 on the standby screen, is further displayed in the operation guide area 1001 of the standby screen 1500 shown in FIG. 15. In FIG. 19, "Abnormal (liquid amount)" indicating that the amount of liquid 70 in the collection container 4 is larger than the predetermined amount is displayed in the collection container liquid amount indicator 1901.

Returning to FIG. 18, when "Abnormal (liquid amount)" is displayed in the collection container liquid amount indicator 1901, the operator performs the waste liquid disposal operation (S1813). When it is detected that the collection container 4 subjected to the waste liquid disposal operation has been set (S1814; YES), the operation display unit 8 changes the display of the collection container liquid amount indicator 1901 from "Abnormal" to "Normal" (S1815). When the next scheduled operation time comes, the inkjet recording device 600 starts the idle-mode automatic circulation process (S1816).

FIG. 20 is a diagram showing an example of the standby screen when the collection container 4 subjected to the waste liquid disposal operation is set during the execution of the idle-mode automatic circulation process. As can be seen from FIG. 20, the collection container liquid amount indicator 1901 on the standby screen shown in FIG. 19 has been changed from "Abnormal (liquid amount)" to "Normal (liquid amount)".

On the other hand, when it is not detected that the collection container 4 subjected to the waste liquid disposal operation has been set (S1814; NO) and the display of the collection container liquid amount indicator 1901 is "Abnormal (liquid amount)" even though the next scheduled operation time has come, the operation display unit 8 displays a warning message (S1817).

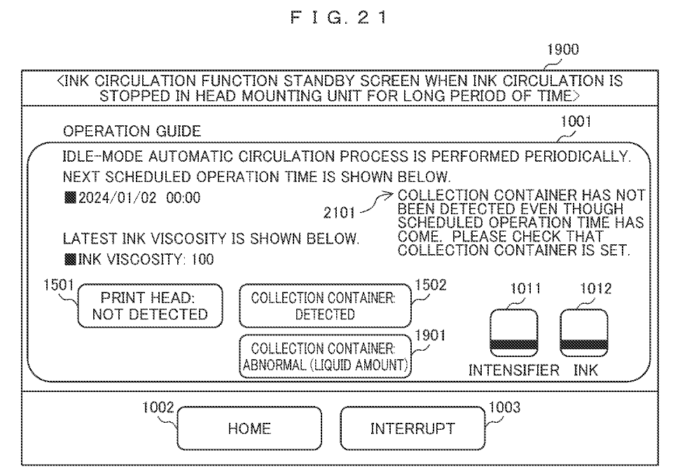

FIG. 21 is a diagram showing an example of the standby screen on which the warning message is displayed. As can be seen from FIG. 21, since the collection container 4 subjected to the waste liquid disposal operation has not been set even though the next scheduled operation time has come, a warning message 2101 that indicates the fact and prompts the operator to set the collection container 4 subjected to the waste liquid disposal operation is displayed.

As described above, it is possible to obtain the same effects as those in the case of the direct operation even when not only the direct operation based on the operator’s determination but also the detection direct operation based on the detection results of the sensors of the inkjet recording device 600 is performed. For example, even when the sensor detects that the amount of liquid 70 in the collection container is greater than the predetermined amount, it is possible to perform the waste liquid disposal operation, without stopping the idle-mode automatic circulation process, while displaying the standby screen.

Each process has been described above using the drawings. As described with reference to FIG. 1, FIGS. 8 to 21, and the like, an inkjet recording device (for example, the inkjet recording device 600) that ejects ink supplied from an ink container from a nozzle to a printing target includes: a control unit (for example, the control unit 7) that executes an idle-mode ink circulation process (idle-mode ink automatic circulation process) of circulating ink in an idle state of the inkjet recording device, the idle-mode ink circulation process repeating the circulation of the ink in a path and a standby state at a predetermined time interval (for example, the content of the settings in (1) the ink circulation start time setting field shown in FIG. 7); and an operation display unit (for example, the operation display unit 8) that displays a standby screen (for example, the standby screen 1000) for the idle-mode ink circulation process. The operation display unit displays information (for example, the HOME button 1002, the indicators 1011 and 1012 for cartridge replacement, the indicators 1501 and 1502 indicating the attachment states, and the indicator 1901 indicating the detection state) for operating the inkjet recording device on the standby screen in a state in which the control unit maintains the execution of the idle-mode ink circulation process, and the inkjet recording device receives an operation on the inkjet recording device based on the information displayed on the standby screen. Therefore, it is possible to perform operations on the inkjet recording device, without performing operations, such as the interruption of the ink circulation process in the idle state and resetting, in a state in which the execution of the ink circulation process is maintained.

As described with reference to FIGS. 9 and 10 and the like, the information for the operation is an object (for example, the HOME button 1002) receiving an operation of changing to a home screen for receiving operations from an operator when the inkjet recording device is started, and the operation display unit receives pressing of the object, changes to the home screen, and receives an operation controlled by software on the home screen. Therefore, the operator can only touch the standby screen to display the home screen and perform various operations.

As described with reference to FIGS. 9 and 11 and the like, an object (for example, the back button 1104) for returning to the standby screen is displayed on the home screen, and the operation display unit returns to the standby screen when the operation controlled by the software is performed and the object is pressed. Therefore, the operator can only touch the screen after ending an operation to return to the original standby state.

As described with reference to FIGS. 14 to 16 and the like, the information for the operation is an indicator (for example, the print head indicator 1501 or the collection container indicator 1502) indicating an attachment state of a physical mechanism (for example, the print head 2 or the collection container 4) that is not used for circulating the ink, and the operation display unit changes display of the indicator (for example, change the display from "Abnormal" to "Normal") when the physical mechanism is attached to the inkjet recording device. Therefore, the operator can only glance at the indicators on the screen to easily check the results of the operations performed on the inkjet recording device.

As described with reference to FIGS. 14 and 17 and the like, the operation display unit displays, on the standby screen, a time when the ink is circulated based on the predetermined time interval, and, when the physical mechanism is not attached even though the time comes, the operation display unit displays a warning message on the standby screen. Therefore, after the operator has performed an operation on the ink jet recording device, the operator can easily check that an operation necessary for the idle-mode automatic circulation process has not been performed.

As described with reference to FIGS. 14 to 16 and the like, the physical mechanism is a print head or a cleaning liquid collection container. Therefore, it is possible to carry out the above-mentioned check for the print head or the cleaning liquid collection container.

As described with reference to FIGS. 18 to 20 and the like, the information for the operation is an indicator (for example, the collection container liquid amount indicator 1901) indicating a detection state of an amount of liquid (for example, the amount of liquid 70) in a cleaning liquid collection container attached as the physical mechanism to the inkjet recording device, and the operation display unit changes display of the indicator (for example, changes the display from "Normal" to "abnormal") when the detection state satisfies a predetermined condition (for example, that the amount of liquid 70 is larger than the predetermined amount). Therefore, the operator can only glance at the indicators on the screen to easily check the detection results of the inkjet recording device.

As described with reference to FIGS. 18 to 20 and the like, the operation display unit displays, on the standby screen, a time when the ink is circulated based on the predetermined time interval, and the operation display unit displays a warning message on the standby screen when the detection state is maintained even though the time comes and the physical mechanism is not attached even though the time comes. Therefore, it is possible to easily check that the operator has not performed the operation required for the idle-mode automatic circulation process, based on the detection results of the inkjet recording device.

The present invention is not limited to the above-described embodiments. In an implementation stage, the components can be modified and embodied without departing from the scope of the present invention, or a plurality of components disclosed in the above-described embodiments can be appropriately combined.

For example, in the idle-mode automatic circulation process described in Embodiments 1 and 2, when the set ink ejection reservation time has not come in Step S811 of FIG. 8 (S811; NO), the process proceeds to Step S821, and the idle-mode automatic circulation process is executed. However, after a job executing the printing process is ended, the inkjet recording device 600 may detect that the print head or the collection container has been attached and may start the process in Step S821 and the subsequent steps. In this case, it is possible to execute the idle-mode automatic circulation process, without being affected by the ink ejection reservation time.

### Explanation of Symbols

1 Main body, 2 Print head, 3 Head mounting unit, 4 Collection container, 5 Cable (for print head), 6 Cable (for head mounting unit), 7 Control unit, 8 Operation display unit, 11 Belt conveyor, 12A Printing target, 12B Printing target, 13 Print head fixing bracket, 16 Head base, 17 Protective cover, 18 Start button, 19 Stop button, 20 Display unit, 21 Nozzle, 23 Charging electrode, 24 Deflection electrode, 24A Positive electrode, 24B Ground electrode, 25 Gutter, 26 Switching valve, 27 Temperature sensor A, 28 Magnetic sensor C, 28A Electric wire, 31 Ink container, 31A Liquid level sensor, 32 Auxiliary ink container, 33 Solvent container, 34 Pump (for supply), 35 Pump (for collection), 36 Pump (for circulation), 37 Pump (for solvent), 39 Filter (for supply), 40 Filter (for collection), 41 Filter (for nozzle cleaning), 43 Filter (for head cleaning), 45 Viscosity measurement device, 46 Pressure adjusting valve, 47 Pressure sensor, 48 Charge sensor, 49 Solenoid valve (for supply), 50 Solenoid valve (for collection), 53 Solenoid valve (for solvent replenishment), 54 Solenoid valve (for ink replenishment), 55 Solenoid valve (for nozzle cleaning), 56 Solenoid valve (for head cleaning), 57 Solenoid valve (for viscosity measurement), 58 Solenoid valve (for main body circulation), 59 Solenoid valve (for circulation), 60 Pump (for drying), 61 Pump (for suction), 62 Exhaust duct connection portion, 68A Ink, 68B Ink particle, 68B1 Ink particle, 68B2 Charged particle, 68C Ink, 69A Solvent, 70 Liquid, 71 Cleaning tank, 71A Attachment portion, 72 Cleaning nozzle, 72A Liquid ejection hole A portion, 72B Liquid ejection hole B portion, 73 Air supply nozzle, 73A Air ejection hole, 74 Float, 75 Magnet A, 76 Magnetic sensor A, 76A Electric wire, 77 Container, 77A Attachment portion, 77B Liquid storage portion, 77C Internal screw portion, 78 Partition, 78A Liquid inflow hole portion, 78B Liquid outflow hole portion, 79 Holder, 80 temperature sensor B, 80A Electric wire, 81 Cleaning block, 81A Head mounting portion, 81B Head insertion portion, 81C Hole portion, 81D Flow path A portion, 81E Flow path B portion, 81F Flow path C portion, 82 Lid hinge, 83 Lid member, 84 Magnetic sensor B, 84A Electric wire, 85 Cover, 86 Magnet B, 87 Magnet C, 88 Suction joint, 88A Chamber, 88B Joint A portion, 88C joint B portion, 89 Liquid joint, 90 Air joint, 91 Fixing portion, 92 Fixing jig (for conveyor), 93 Joint portion, 301 MPU, 302 Bus line, 306 ROM, 307 RAM, 311 Viscosity measurement circuit, 312 Pressure detection circuit, 313 Liquid level detection circuit, 314 Pump control circuit, 315 Solenoid valve driving circuit, 321 Air pump control circuit, 322 Collection container sensor detection circuit, 323 Print head detection circuit, 324 Head mounting unit detection circuit, 331 Excitation voltage generation circuit, 332 Deflection voltage generation circuit, 341 Phase search charging signal generation circuit, 342 Printing charging signal generation circuit, 343 D/A converter, 344 Amplifier circuit, 351 Phase determination circuit, 352 A/D converter, 353 Amplifier circuit, 600 Inkjet recording device, 801 to 804 Path (for supply), 806 Path (for replenishment), 808 Path (for main body circulation), 811 and 812 Path (for collection), 814 Path (for exhaust), 821 and 822 Path (for head circulation), 824 Path (for viscosity measurement), 831 Path (for solvent supply), 833 Path (for solvent replenishment), 835 Path (for nozzle cleaning), 837 Path (for head cleaning), 841 Path (for air supply), 843 Path (for air suction), 901 to 903 Junction path, 921 and 922 Branch path

What is claimed is:

1. An inkjet recording device ejecting ink supplied from an ink container from a nozzle to perform printing on a printing target, the inkjet recording device comprising:
a control unit executing an idle-mode ink circulation process of circulating ink in an idle state of the inkjet recording device, the idle-mode ink circulation process repeating the circulation of the ink in a path and a standby state at a predetermined time interval; and
an operation display unit displaying a standby screen for the idle-mode ink circulation process,
wherein the operation display unit displays information for operating the inkjet recording device on the standby screen in a state in which the control unit maintains the execution of the idle-mode ink circulation process, and
the inkjet recording device receives an operation on the inkjet recording device based on the information displayed on the standby screen.

2. The inkjet recording device according to claim 1,
wherein the information for the operation is an object receiving an operation of changing to a home screen for receiving operations from an operator when the inkjet recording device is started, and
the operation display unit receives pressing of the object, changes to the home screen, and receives an operation controlled by software on the home screen.

3. The inkjet recording device according to claim 2,
wherein an object for returning to the standby screen is displayed on the home screen, and
the operation display unit returns to the standby screen when the operation controlled by the software is performed and the object is pressed.

4. The inkjet recording device according to claim 1,
wherein the information for the operation is an indicator indicating an attachment state of a physical mechanism that is not used for circulating the ink, and
the operation display unit changes display of the indicator when the physical mechanism is attached to the inkjet recording device.

5. The inkjet recording device according to claim 4,
wherein the operation display unit displays, on the standby screen, a time when the ink is circulated based on the predetermined time interval, and
when the physical mechanism is not attached even though the time comes, the operation display unit displays a warning message on the standby screen.

6. The inkjet recording device according to claim 4,
wherein the physical mechanism is a print head or a cleaning liquid collection container.

7. The inkjet recording device according to claim 1,
wherein the information for the operation is an indicator indicating a detection state of an amount of liquid in a cleaning liquid collection container attached as the physical mechanism to the inkjet recording device, and
the operation display unit changes display of the indicator when the detection state satisfies a predetermined condition.

8. The inkjet recording device according to claim 7,
wherein the operation display unit displays, on the standby screen, a time when the ink is circulated based on the predetermined time interval, and
the operation display unit displays a warning message on the standby screen when the detection state is maintained even though the time comes and the physical mechanism is not attached even though the time comes.

9. A method for controlling an inkjet recording device ejecting ink supplied from an ink container from a nozzle to perform printing on a printing target, the method comprising:
causing a control unit to execute an idle-mode ink circulation process of circulating ink in an idle state of the inkjet recording device, the idle-mode ink circulation process repeating the circulation of the ink in a path and a standby state at a predetermined time interval;
causing an operation display unit to display a standby screen for the idle-mode ink circulation process;
causing the operation display unit to display information for operating the inkjet recording device on the standby screen in a state in which the control unit maintains the execution of the idle-mode ink circulation process; and
causing the inkjet recording device to receive an operation on the inkjet recording device based on the information displayed on the standby screen.
